(19) United States
(12) Patent Application Publication
(10) Pub. No.: US 2024/0428047 A1
(43) Pub. Date: Dec. 26, 2024

(54) SPIKING NEURAL NETWORK CIRCUITS GENERATING SPIKE SIGNALS AND METHOD OF OPERATION THEREOF

(71) Applicant: Electronics and Telecommunications Research Institute, Daejeon (KR)

(72) Inventors: Kwang IL OH, Daejeon (KR); Tae Wook KANG, Daejeon (KR); Hyuk KIM, Daejeon (KR); Jae-Jin LEE, Daejeon (KR)

(73) Assignee: Electronics and Telecommunications Research Institute, Daejeon (KR)

(21) Appl. No.: 18/422,776

(22) Filed: Jan. 25, 2024

(30) Foreign Application Priority Data
Jun. 22, 2023 (KR) 10-2023-0080391

(51) Int. Cl. G06N 3/04; G06N 3/063

(52) U.S. Cl. CPC G06N 3/04; G06N 3/063

(57) ABSTRACT

Disclosed is a spiking neural network circuit, which includes an axon circuit that generates first and second input spike signals, a synapse circuit that generates a first current based on the first input spike signal and a weight and generates a second current based on the second input spike signal and the weight, a capacitor that forms a first membrane voltage based on the first current, and a neuron circuit including a comparator and that resets the first membrane voltage, and after the capacitor further forms a second membrane voltage based on the second current, and the comparator includes a first input terminal and a second input terminal, receives the first membrane voltage through the first input terminal and a reference voltage through the second input terminal, generates a first spike signal based on a first comparison operation of the first membrane voltage and the reference voltage.

### CROSS-REFERENCE TO RELATED APPLICATIONS

This application claims priority under 35 U.S.C. § 119 to Korean Patent Application No. 10-2023-0080391 filed on Jun. 22, 2023, in the Korean Intellectual Property Office, the disclosures of which are incorporated by reference herein in their entireties.

### BACKGROUND

Embodiments of the present disclosure described herein relate to a spiking neural network circuit, and more particularly, relate to a spiking neural network circuit that generates spike signals and an operation method of thereof.

A spiking neural network (SNN) circuit is one of the methods of implementing an artificial intelligence network that performs network calculations on inputs and transmits outputs. Spiking neural networks may be implemented with the spiking neural network circuit using a semiconductor device. Spiking neural network circuits transfer inputs and signals in the form of pulses or spikes with a short time width.

The spiking neural network circuits perform calculations in a synapse circuit so as to be transferred to the neuron circuit. In this case, a voltage or charge provided from a synapse circuit is accumulated in a membrane capacitor of the neuron circuit, and when the accumulated voltage or charge exceeds a threshold voltage, a neuron fires. Therefore, the precision of a comparator that performs the operation of comparing the charge accumulated in the membrane capacitor with a threshold voltage becomes an important factor in determining outputs. However, unlike an ideal comparator, typical comparators have problems in that the timing at which spikes are output is inaccurate as an input voltage varies due to an offset voltage.

### SUMMARY

Embodiments of the present disclosure provide a spiking neural network circuit that generates a spike signal and a method of operating the same are provided.

According to an embodiment of the present disclosure, a spiking neural network circuit includes an axon circuit that generates first and second input spike signals, a synapse circuit that generates a first current based on the first input spike signal and a weight and generates a second current based on the second input spike signal and the weight, a capacitor that forms a first membrane voltage based on the first current, and a neuron circuit including a comparator and that resets the first membrane voltage, and after the capacitor is reset by the neuron circuit, and further forms a second membrane voltage based on the second current, and the comparator includes a first input terminal and a second input terminal, receives the first membrane voltage through the first input terminal and a reference voltage through the second input terminal, generates a first spike signal based on a first comparison operation of the first membrane voltage and the reference voltage, resets the first membrane voltage of the capacitor based on the first spike signal, receives the reference voltage through the first input terminal and the second membrane voltage through the second input terminal based on the first spike signal, generates a second spike signal based on a second comparison operation of the reference voltage and the second membrane voltage.

According to an embodiment, the neuron circuit may further include an output spike generator, and the output spike generator may receive the first spike signal and the second spike signal, may generate a first input/output inverted signal based on the first spike signal, and may generate a second input/output inverted signal and an output spike signal based on the second spike signal.

According to an embodiment, the neuron circuit may change a voltage that the comparator receives through the first input terminal from the first membrane voltage to the reference voltage, based on the first input/output inverted signal, and may change a voltage that the comparator receives through the second input terminal from the reference voltage to the second membrane voltage.

According to an embodiment, the axon circuit may further generate a third input spike signal, the synapse circuit may further generate a third current based on the third input spike signal and the weight, the capacitor may further form a third membrane voltage based on the third current after the second membrane voltage is reset by the neuron circuit, and the comparator may receive the third membrane voltage through the first input terminal and the reference voltage through the second input terminal, may generate a third spike signal based on a third comparison operation of the third membrane voltage and the reference voltage, and may reset the second membrane voltage of the capacitor based on the third spike signal.

According to an embodiment, the neuron circuit may further include an output spike generator that receives the second spike signal and generates a second input/output inverted signal and an output spike signal based on the second spike signal, and may change a voltage that the comparator receives through the first input terminal from the reference voltage to the third membrane voltage based on the second input/output inverted signal, and may change a voltage that the comparator receives through the second input terminal from the second membrane voltage to the reference voltage.

According to an embodiment, the output spike generator may include a first flip-flop circuit that generates a first input/output inverted signal based on the first spike signal, and generates a second input/output inverted signal based on the second spike signal, and a second flip-flop circuit that generates the output spike signal based on the second input/output inverted signal.

According to an embodiment, the first input terminal may be a non-inverting input terminal, and the second input terminal may be an inverting input terminal.

According to an embodiment, the comparator may further include a non-inverting output terminal and an inverting output terminal, and the comparator may output the first spike signal through the non-inverting output terminal and may output the second spike signal through the inverting output terminal.

According to an embodiment of the present disclosure, a method of operating a spiking neural network circuit including an axon circuit, a synapse circuit, and a neuron circuit, includes generating, by the axon circuit, a first input spike signal, outputting, by the synapse circuit, a first current based on the first input spike signal and a weight, generating, by a capacitor of the neuron circuit, a first membrane voltage based on the first current, receiving, by a comparator of the neuron circuit, the first membrane voltage through a first input terminal of the comparator and a reference voltage through a second input terminal of the comparator, generating, by the comparator, a first spike signal based on the first membrane voltage and the reference voltage, resetting, by the neuron circuit, the first membrane voltage based on the first spike signal, generating, by the axon circuit, a second input spike signal, outputting, by the synapse circuit, a second current based on the second input spike signal and a weight, forming, by the capacitor, a second membrane voltage based on the second current, receiving, by the comparator, the reference voltage through the first input terminal and the second membrane voltage through the second input terminal, and generating, by the comparator, a second spike signal based on the reference voltage and the second membrane voltage.

According to an embodiment, the neuron circuit may further include an output spike generator, and the generating, by comparator, of the first spike signal based on the first membrane voltage and the reference voltage may further include generating, by the output spike generator, a first input/output inverted signal based on the first spike signal, and the receiving, by the comparator, of the reference voltage through the first input terminal and of the second membrane voltage through the second input terminal may include changing, by the neuron circuit, a voltage that the comparator receives through the first input terminal from the first membrane voltage to the reference voltage, based on the first input/output inverted signal, and changing, by the neuron circuit, a voltage that the comparator receives through the second input terminal from the reference voltage to the second membrane voltage, based on the first input/output inverted signal.

According to an embodiment, the method may further include generating, by the axon circuit, a third input spike signal, generating, by the synapse circuit, a third current based on the third input spike signal and the weight, forming, by the capacitor, a third membrane voltage based on the third current, receiving, by the comparator, the third membrane voltage through the first input terminal and the reference voltage through the second input terminal, and generating, by the comparator, a third spike signal based on the third membrane voltage and the reference voltage.

According to an embodiment, the neuron circuit may further include an output spike generator, and the generating, by the comparator, of the second spike signal based on the reference voltage and the second membrane voltage may further include generating, by the output spike generator, a second input/output inverted signal based on the second spike signal, and the receiving, by the comparator, of the third membrane voltage through the first input terminal and of the reference voltage through the second input terminal may include changing, by the neuron circuit, a voltage that the comparator receives through the second input terminal from the reference voltage to the third membrane voltage, based on the second input/output inverted signal, and changing, by the neuron circuit, a voltage that the comparator receives through the second input terminal from the second membrane voltage to the reference voltage, based on the second input/output inverted data.

According to an embodiment, the generating, by the output spike generator, of the second input/output inverted signal based on the second spike signal may further include generating, by the output spike generator, a first output spike signal based on the second spike signal.

According to an embodiment, the comparator may include a non-inverting output terminal and an inverting output terminal, and the comparator may output the first spike signal through the non-inverting output terminal and may output the second spike signal through the inverting output terminal.

### BRIEF DESCRIPTION OF DRAWINGS

The above and other objects and features of the present disclosure will become apparent by describing in detail embodiments thereof with reference to the accompanying drawings.

FIG. 1 is a diagram illustrating a spiking neural network circuit, according to an embodiment of the present disclosure.

FIG. 2 is a diagram illustrating a spiking neural network circuit, according to an embodiment of the present disclosure.

FIG. 3 is a timing diagram describing operations of a synapse circuit and a neuron circuit with respect to an input spike signal in a general spiking neural network circuit.

FIG. 4 is a diagram illustrating a neuron circuit of a general spiking neural network circuit.

FIG. 5 is a timing diagram describing operations of a synapse circuit and a neuron circuit with respect to an input spike signal in a general spiking neural network circuit.

FIG. 6 is a diagram of a neuron circuit of a spiking neural network circuit, according to an embodiment of the present disclosure.

FIG. 7 is a detailed diagram illustrating an output spike generator of FIG. 6, according to some embodiments of the present disclosure.

FIG. 8 is a timing diagram describing an operation of a spiking neural network circuit, according to some embodiments of the present disclosure.

FIG. 9 is a flowchart describing an operation of a neuron circuit, according to an embodiment of the present disclosure.

### DETAILED DESCRIPTION

Hereinafter, embodiments of the present disclosure will be described in detail and clearly to such an extent that an ordinary one in the art easily implements the present disclosure.

Hereinafter, several embodiments of the present disclosure will be described in more detail with reference to accompanying drawings. Hereinafter, in order to facilitate overall understanding in describing the present disclosure, similar reference numerals are used for similar components in the drawings, and in order to clearly descript the technical idea of the present disclosure, detailed descriptions of overlapping components will be omitted to avoid redundancy.

The present disclosure relates to a circuit implemented in a semiconductor device to perform neural network calculations. The neural network of the present disclosure may be an artificial neural network (ANN) that may process data or information in a manner similar to a biological neural network. The neural network may include multiple layers containing artificial neurons similar to biological neurons and synapses connecting the multiple layers. Hereinafter, a spiking neural network that processes a spike signal having a pulse shape that toggles for a short period of time will be representatively described. However, the circuit according to an embodiment of the present disclosure is not limited to the spiking neural network and may also be used to implement other neural networks.

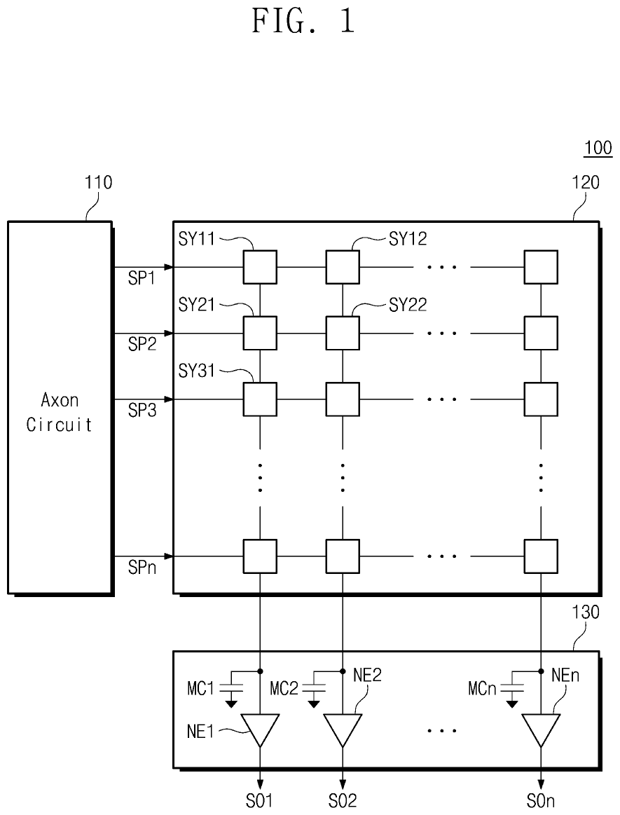

FIG. 1 is a diagram illustrating a spiking neural network circuit, according to an embodiment of the present disclosure. Referring to FIG. 1, a spiking neural network circuit 100 is illustrated.

An axon circuit 110 may include axons that generate input spike signals. The axon of the axon circuit 110 may perform the function of outputting signals to other neurons, similar to the axon of a biological neural network. For example, each of the axons of the axon circuit 110 may generate an input spike signal based on data input from the outside to the spiking neural network circuit 100. As another example, each of the axons of the axon circuit 110 may first receive (feedback) output spike signals output from a neuron array 130 according to the input spike signals transmitted to a synapse array 120 and may generate a new input spike signal based on the output spike signals. The input spike signal may be a pulse signal that toggles for a short period of time. The axon circuit 110 may generate input spike signals SP1 to SPn so as to be transmitted to the synapse array 120.

The synapse array 120 may connect the axon circuit 110 to the neuron array 130. The synapse array 120 may include a plurality of synapse circuits (e.g., SY11, SY21, SY31, S12, and S22) that determine whether there is a connection and a strength of the connection between the axons of the axon circuit 110 and neuron circuits NE1 to NEn of the neuron array 130. Each of the synapse circuits may have a corresponding weight. Each of the synapse circuits may receive an input spike signal, and a weight may be applied to the received input spike signal. For example, the synapse circuits may perform calculations to apply respective weights to the received input spike signal. The weight may be a numerical value representing a correlation between the axons described above and neuron circuits, a connection strength between the axons of the axon circuit 110 and the neuron circuits of the neuron array 130, and a correlation of (subsequent) neuron circuits of the neuron array 130 with respect to the input spike signal. For example, the synapse array 120 may output a result to which the weight is applied with respect to the input spike signals to the neuron array 130. The result to which the weight is applied with respect to the input spike signals may be a current or a charge.

Referring to FIG. 1, the synapse array 120 is illustrated as a two-dimensional array, and the synapse circuits are illustrated as being arranged on the two-dimensional array. For example, the input spike signals may be transmitted in a first direction from the axon circuit 110 to the synapse array 120. The result to which the weight is applied with respect to the input spike signals may be transmitted in a second direction from the synapse array 120 to the neuron array 130. For example, the first direction and the second direction may be perpendicular to each other. However, unlike the illustration in FIG. 1, the synapse circuits may be arranged on a three-dimensional array.

The neuron array 130 may include membrane capacitors MC1 to MCn and the neuron circuits NE1 to NEn.

Each of the membrane capacitors MC1 to MCn may be connected between a node connected to the synapse array 120 and a ground node. Each of the membrane capacitors MC1 to MCn may accumulate the result to which the weight is applied with respect to the input spike signals received from the synapse array 120. For example, the membrane capacitor may receive a current from the synapse array 120 to form a membrane voltage.

For brief description, the present disclosure is mainly described in a case where a voltage of the membrane capacitor increases as the result to which the weight is applied with respect to the input spike signals is accumulated. However, the scope of the present disclosure is not limited thereto, and the present disclosure includes a case where a voltage of the membrane capacitor decreases as calculation signals are accumulated.

Each of the neuron circuits NE1 to NEn may have a threshold voltage. The threshold voltage may also be referred to as a reference voltage and may be a preset voltage level. Each of the neuron circuits NE1 to NEn may generate an output spike signal based on the corresponding membrane voltage and threshold voltage.

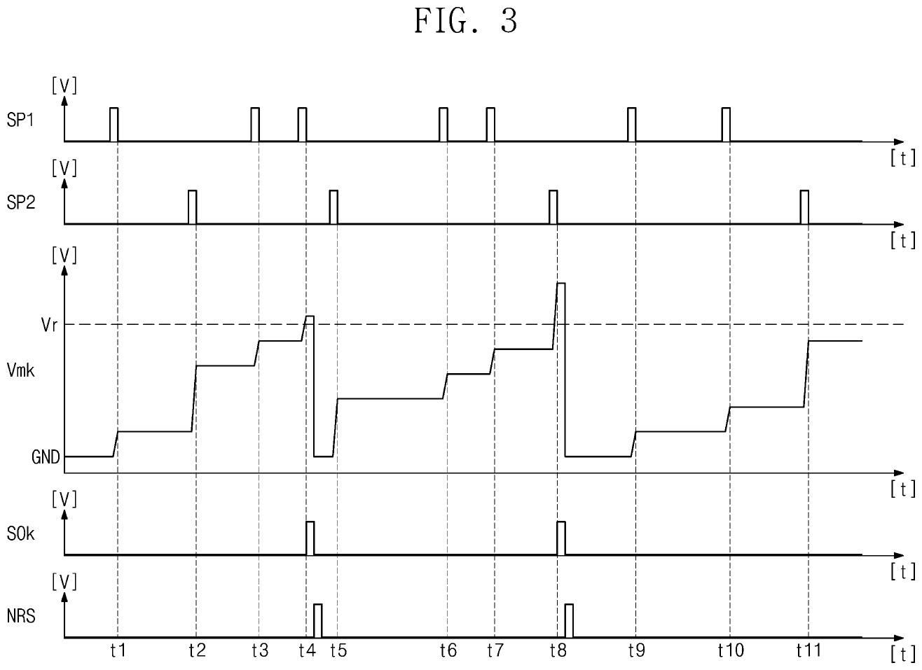

For example, the first neuron circuit NE1 may output a first output spike signal SO1 when the membrane voltage formed in the first membrane capacitor MC1 is greater than a reference voltage. The membrane voltage formed in the first membrane capacitor MC1 is greater than the reference voltage, so the first neuron circuit NE1 outputs the first output spike signal SO1, which means that the first neuron circuit NE1 fires. A more detailed description of the neuron circuit will be described later with reference to FIG. 3.

The output spike signals SO1 to SOn output from the neuron array 130 may be provided back to the axon circuit 110, may be output to the outside of the spiking neural network circuit 100, or may be output to other components of the spiking neural network circuit 100.

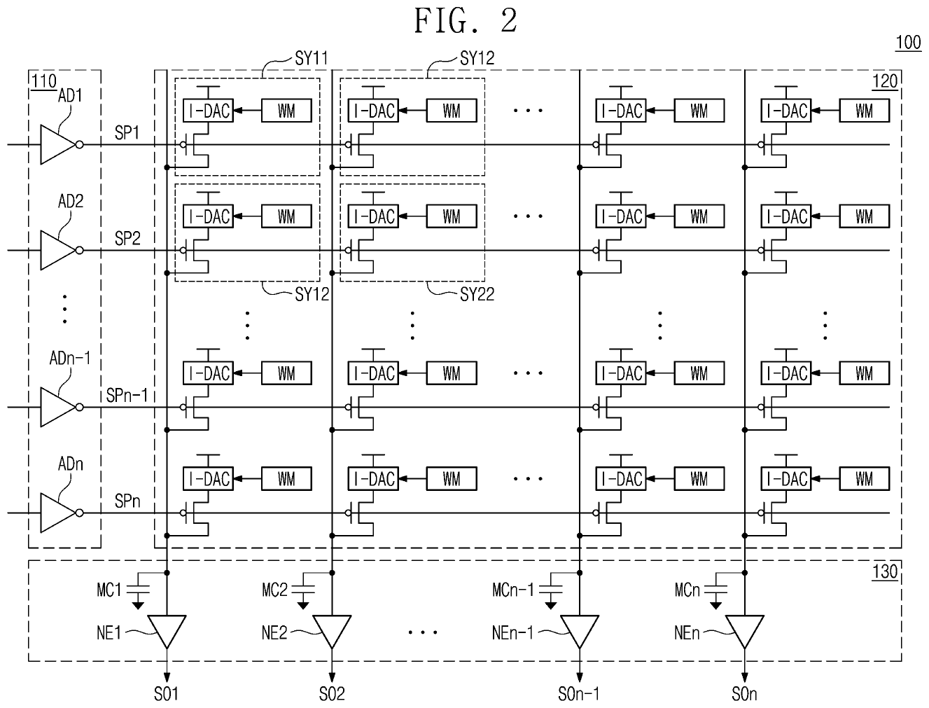

FIG. 2 is a diagram illustrating a spiking neural network circuit, according to an embodiment of the present disclosure. Referring to FIG. 2, an example circuit diagram of the axon circuit 110 and the synapse array 120 of FIG. 1 is illustrated. Since the neuron array 130 in FIG. 2 is the same as the neuron array 130 in FIG. 1, description thereof will be omitted.

The axon circuit 110 may include axon drivers AD1 to ADn. For example, each of the axon drivers AD1 to ADn may be implemented with an inverter. Each of the axon drivers AD1 to ADn may receive an input signal and may transmit the received input signal to the synapse array 120 as the input spike signals SP1 to SPn.

The synapse circuits (e.g., SY11, SY21, SY12, and SY22) of the synapse array 120 may include a transistor, a weight memory WM, and a Current-mode Digital-to-Analog Converter (I-DAC), respectively.

The weight memory WM may store predefined weights. The weight memory WM may provide stored weights to the I-DAC. For example, the weight memory WM may be implemented as a binary memory. The weight memory WM may be implemented as a memory that may store 8 bits. However, the scope of the present disclosure is not limited thereto, and the size of the binary memory may be implemented in various ways depending on the purpose of the spiking neural network circuit.

The I-DAC may receive weights from the weight memory WM. The I-DAC may convert the weights into signals that may be applied to the input spike signal.

For a concise description, a transistor of the synapse circuit will be mainly described as an embodiment implemented as a PMOS transistor (p-channel metal-oxide-semiconductor field-effect transistor). A gate terminal of a transistor of the synapse circuit may receive the input spike signal from the axon circuit 110, a source terminal of the transistor may be connected to the I-DAC, and a drain terminal of the transistor may be connected to the same node as a membrane capacitor.

FIG. 3 is a timing diagram describing operations of a synapse circuit and a neuron circuit with respect to an input spike signal in a general spiking neural network circuit. Referring to FIG. 3, a timing diagram illustrating how a general spiking neural network operates is illustrated.

In FIG. 3, a horizontal axis may represent a time “t”, and a vertical axis may represent a voltage “V”. Components having the same reference numerals as the components of FIGS. 1 and 3, which are described with reference to the drawings below, may mean components that are the same as or similar to the components of FIGS. 1 and 3.

When the first input spike signal SP1 and the second input spike signal SP2 are received from each of the two different axons of the axon circuit 110, a membrane voltage Vmk may increase based on the weight determined in the synapse circuit.

In some embodiments, weights corresponding to each of two different axons may be the same or different. For concise and detailed description, it is assumed that the weight corresponding to the second input spike signal SP2 is greater than the weight corresponding to the first input spike signal SP1, but the scope of the present disclosure is not limited thereto.

Continuing to refer to FIG. 3, when the input spike signal is input at a first time to a fourth time t1 to t4 and a fifth time to an eighth time t5 to t8, the membrane voltage Vmk increases (or the membrane capacitor is charged). Among these, at the second time t2, the fifth time t5, the eighth time t8, and the eleventh time t11, the weight corresponding to the second input spike signal SP2 is calculated, so the increase amount (e.g., the increase amount in the membrane voltage Vmk at the second time t2, the fifth time t5, the fifth time t5, and the eighth time t8) in the membrane voltage Vmk by the second input spike signal SP2 may be greater than the increase amount (e.g., the increase amount in the membrane voltage Vmk at the first time t1, the third time t3, the fourth time t4, the sixth time t6, and the seventh time t7) in the membrane voltage Vmk by the first input spike signal SP1.

At the fourth time t4 and the eighth time t8 when the membrane voltage Vmk exceeds a reference voltage Vr, the neuron circuit may fire and may output an output spike signal SOK. In detail, the frequency and timing of the output spike signal output through the firing of the neuron circuit may vary depending on the firing timing of the input spike signal and the size of the weight stored in the synapse circuit.

After a specific delay time after the output spike signal SOK is output, the neuron circuit may output a neuron reset signal NRS to a transistor of which both sides are connected to the ground node and the input terminal of the membrane voltage. When the transistor is turned on by the neuron reset signal NRS, the potential of a membrane voltage Vm may decrease to the potential level of the ground node.

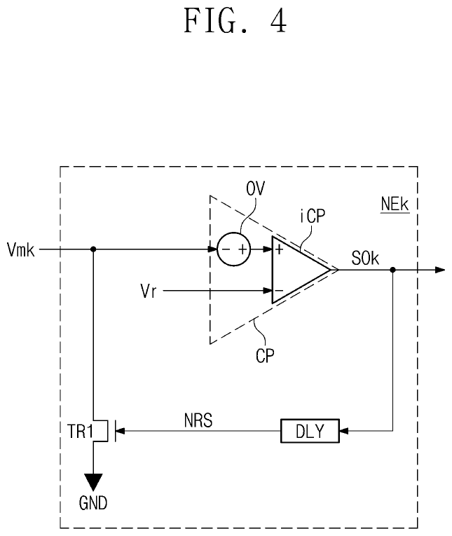

FIG. 4 is a diagram illustrating a neuron circuit of a general spiking neural network circuit. Referring to FIG. 4, a circuit diagram of one neuron circuit NEk among the neuron circuits NE1 to NEn of FIGS. 1 and 2 is illustrated.

The neuron circuit NEK may include a comparator CP, a delay circuit DLY, and a first transistor TR1.

The comparator CP is a general comparator in a spiking neural network circuit, and an offset voltage may occur within the comparator CP due to deviations in a manufacture process. Due to the offset voltage, a distance may occur between the voltages that actually receives through input terminals of the comparator CP and voltages that perform a comparison operation.

For convenience of description, as illustrated in FIG. 4, the comparator CP is illustrated as including an ideal comparator iCP with no offset voltage, and an offset power source OV between a non-inverting input terminal of the ideal comparator iCP and an input terminal of the comparator CP. The offset power source OV may generate a voltage of the same level as the offset voltage. In this case, the offset voltage has a potential difference between the non-inverting input terminal of the ideal comparator iCP and the non-inverting input terminal of the comparator CP.

The comparator CP may include a first input terminal and a second input terminal.

In some embodiments, the first input terminal may be a non-inverting terminal, and the second input terminal may be an inverting terminal.

The comparator CP may receive the membrane voltage Vmk as an input to the first input terminal. The membrane voltage Vmk may refer to the voltage formed by a membrane capacitor MCk corresponding to the neuron circuit NEK. The comparator CP may receive the reference voltage Vr as an input to the second input terminal. The voltage level of the reference voltage Vr may be determined in advance.

The ideal comparator iCP may output the output spike signal SOK by comparing the voltage increased by the offset voltage from the membrane voltage Vmk with the reference voltage Vr.

For example, at the moment when the voltage increased by the offset voltage from the membrane voltage Vmk becomes greater than the reference voltage Vr, the logic value of the output spike signal SOK may be ‘1’. In detail, the neuron circuit NEk may fire. The logic value of ‘1’ may indicate that the voltage of a signal is high. The logic value of ‘0’ may indicate that the voltage of a signal is low. The potential level of the voltage having the low level may be the same as the potential level of the ground node.

In contrast, when the membrane voltage Vmk of the comparator CP is lower than the reference voltage Vr, the logic value of the output spike signal SOk is ‘0’. In detail, the neuron circuit NEk does not fire.

As described above, a calculation in which a comparator compares two voltages may be referred to as a comparison calculation.

In FIG. 4, the offset power source OV is illustrated as connected to the first input terminal, but the scope of the present disclosure is not limited thereto. For example, the ideal comparator iCP and the offset power source OV may be represented such that the reference voltage Vr decreases, rather than the membrane voltage Vmk increases.

The delay circuit DLY may receive the output spike signal SOK and may output the neuron reset signal NRS. There may be a specific time difference between the time when the output spike signal SOK is output and the time when the neuron reset signal NRS is output. The delay circuit DLY may transfer the neuron reset signal NRS to the gate terminal of a first transistor TR1.

The first transistor TR1 may be implemented as an NMOS transistor (n-channel metal-oxide-semiconductor field-effect transistor). The gate terminal of the first transistor TR1 may receive the neuron reset signal NRS from the delay circuit DLY, and upon receiving the neuron reset signal NRS, the first transistor TR1 may be turned on. The source terminal of the first transistor TR1 may be connected to the ground node GND, and the drain terminal thereof may be connected to the same node as the first input terminal of the comparator CP to which the membrane voltage Vmk is applied.

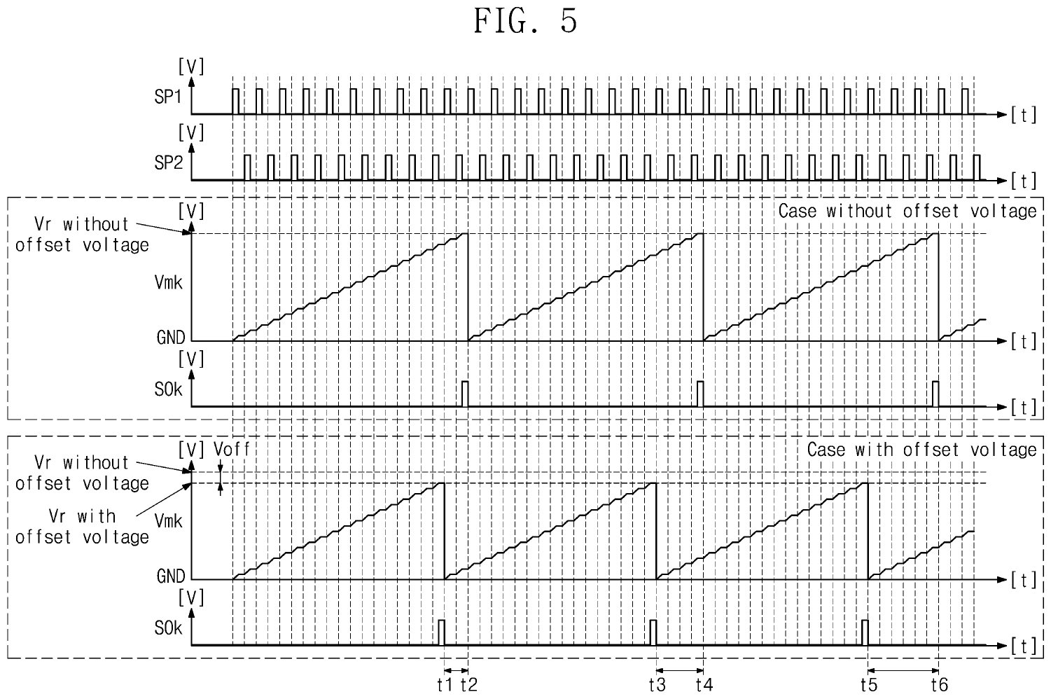

FIG. 5 is a timing diagram describing operations of a synapse circuit and a neuron circuit with respect to an input spike signal in a general spiking neural network circuit. Referring to FIG. 5, a timing diagram illustrating the operations of the synapse circuit and the neuron circuit depending on the presence or absence of the offset voltage is described.

In FIG. 5, a horizontal axis may represent a time “t”, and a vertical axis may represent a voltage “V”. In FIG. 5, signals having the same reference numbers as in FIG. 3 are the same as the signals in FIG. 3. For concise description, descriptions of FIG. 5 that overlap with those of FIG. 3 will be omitted to avoid redundancy.

When there is no offset voltage, the output spike signal SOK may have the logic value of ‘1’ at the second time t2, the fourth time t4, and the sixth time t6.

In contrast, when there is the offset voltage, the reference voltage when there is an offset voltage is the same as being smaller than the reference voltage when there is no offset voltage by an offset voltage Voff, so the output spike signal SOK may have the logic value of ‘1’ at the first time t1, the third time t3, and the fifth time t5.

In detail, in the case of an ideal comparator without the offset voltage and in the case of using a typical comparator, there is a difference in the timing of occurrence of each output spike signal SOK. In detail, timing errors may occur.

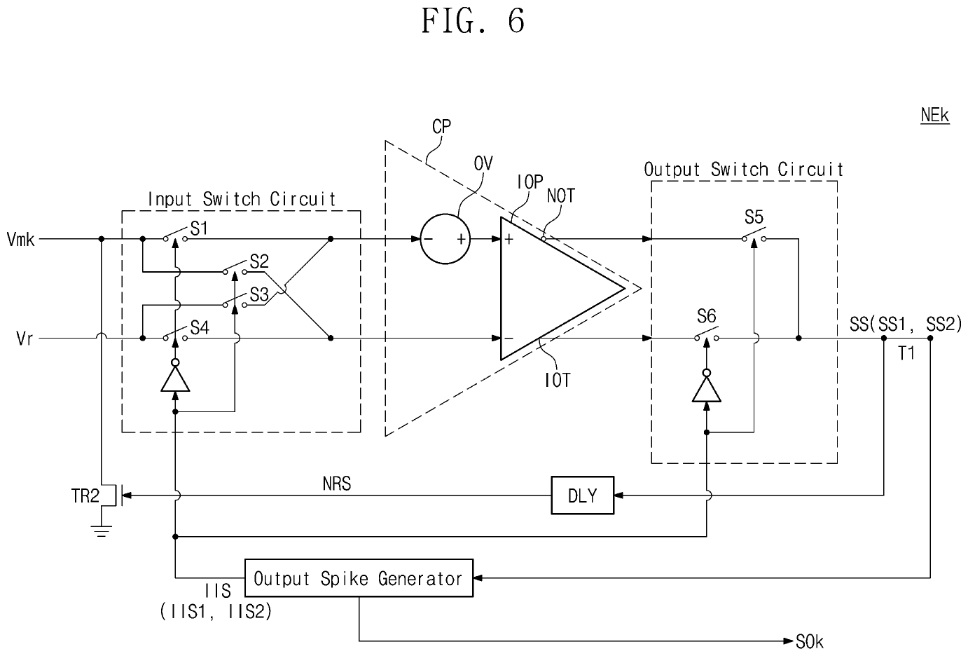

FIG. 6 is a diagram of a neuron circuit of a spiking neural network circuit, according to an embodiment of the present disclosure. Referring to FIG. 6, a circuit diagram of the neuron circuit NEK of a spiking neural network circuit according to an embodiment of the present disclosure is illustrated.

In the spiking neural network circuit according to an embodiment of the present disclosure, the configuration and operation of the axon circuit and the synapse circuit not illustrated in the present disclosure are the same as the axon circuit 110 and the synapse array 120 of FIG. 1, so additional descriptions will be omitted to avoid redundancy.

The neuron circuit NEK may include an input switch circuit, the comparator CP, an output switch circuit, the delay circuit DLY, a second transistor T2, and an output spike generator.

The input switch circuit may include first to fourth switches S1 to S4. The first switch S1 may be located between a membrane voltage terminal and a first input terminal of the comparator CP. The second switch S2 may be located between the membrane voltage terminal and a second input terminal of the comparator CP. The third switch S3 may be located between a reference voltage terminal and the first input terminal. The fourth switch S4 may be located between the reference voltage terminal and the second input terminal.

First, the first switch S1 and the fourth switch S4 may be closed, and the second switch S2 and the third switch S3 may be opened. Accordingly, the comparator CP may receive the membrane voltage Vmk and the reference voltage Vr through the first input terminal and the second input terminal, respectively. However, in this case, the potential level of the reference voltage Vr may be half of the potential level of the reference voltage Vr in FIGS. 3 and 4.

The input switch circuit may receive an input/output inverted signal IIS from the output spike generator. The input/output inverted signal IIS may have a logic value of ‘0’ or ‘1’. A more detailed description of the input/output inverted signal IIS along with the output spike generator will be described later.

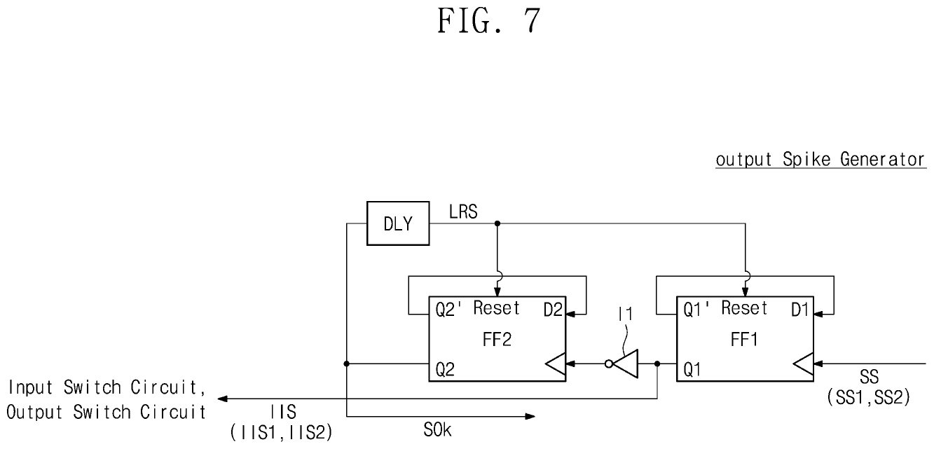

In the input switch circuit, each of the first to fourth switches S1 to S4 may be opened or closed based on each of input/output inverted signals IIS1 and IIS2. The input/output inverted signal IIS may sequentially include the first input/output inverted signal IIS1 and the second input/output inverted signal IIS2. However, the scope of the present disclosure is not limited thereto, and two or more input/output inverted signals may occur. A more detailed description of the input/output inverted signal IIS will be described later with reference to FIG. 7.

For example, when the first input/output inverted signal ISSI has the logic value ‘1’, the first switch S1 and the fourth switch S4 may be closed, and the second switch S2 and the third switch S3 may be opened. Accordingly, the comparator CP may receive the membrane voltage Vmk and the reference voltage Vr through the first input terminal and the second input terminal, respectively.

In contrast, when the second input/output inverted signal IIS2 has the logic value ‘0’, the second switch S2 and the third switch S3 may be closed, and the first switch S1 and the fourth switch S4 may be opened. Accordingly, the comparator CP may again receive the membrane voltage Vmk and the reference voltage Vr through the first input terminal and the second input terminal, respectively.

The comparator CP may include the offset power source OV and the ideal comparator iCP. The offset power source OV and the ideal comparator iCP may correspond to the offset power source OV and the ideal comparator iCP in FIG. 4, respectively.

First, a case in which the membrane voltage Vmk and the reference voltage Vr are respectively input to the first and second input terminals of the comparator CP may be described below.

The comparator CP may receive the membrane voltage Vmk through the first input terminal and the reference voltage Vr through the second input terminal.

The comparator CP may generate a first spike signal SS1 based on the membrane voltage Vmk and the reference voltage Vr.

For example, the comparator CP applies a comparison calculation to the membrane voltage Vmk increased by the offset voltage and the reference voltage Vr to determine whether the membrane voltage Vmk increased by the offset voltage is greater than the reference voltage Vr. When it is determined that it is greater than the reference voltage Vr, the logic value ‘1’ may be generated as the result of the comparison calculation.

In this case, the comparator CP may output the logic value ‘1’ as the first spike signal SSI through a non-inverting output terminal NOT. The non-inverting output terminal NOT may be a terminal that outputs the result of the comparison operation as is.

Next, as the input switch circuit receives the input/output inverted signal IIS from the output spike generator, a case in which the reference voltage Vr and the membrane voltage Vmk are respectively input to the first and second input terminals of the comparator CP may be described below.

The comparator CP may apply a comparison calculation to the reference voltage Vr increased by the offset voltage and the membrane voltage Vmk to determine whether the reference voltage Vr increased by the offset voltage is greater than the membrane voltage Vmk. When it is determined that the reference voltage Vr increased by the offset voltage is greater than the membrane voltage Vmk, the comparator CP may generate the logic value ‘1’ as the result of the comparison calculation. In contrast, when it is determined that the membrane voltage Vmk is greater than the reference voltage Vr increased by the offset voltage, the comparator CP may generate the logic value ‘0’ as the result of the comparison calculation.

In this case, the comparator CP may invert the logic value ‘0’ through an inverting output terminal IoT and may output the logic value ‘1’ as a second spike signal SS2. The inverting output terminal IoT may be a terminal that inverts the result of the comparison calculation so as to be output.

The output switch circuit may include a fifth switch S5 and a sixth switch S6.

The fifth switch S5 may be located between the non-inverting output terminal NOT of the comparator CP and a first terminal T1. The first terminal T1 may be connected to the delay circuit DLY and the output spike generator.

The fifth switch S6 may be located between the inverting output terminal IoT of the comparator CP and the first terminal T1.

First, the fifth switch S5 may be closed and the sixth switch S6 may be opened. In detail, the first spike signal SS1 output through the non-inverting output terminal NOT may be provided to the delay circuit DLY and the output spike generator through the first terminal T1.

The fifth switch S5 and the sixth switch S6 may receive the input/output inverted signal IIS from the output spike generator and may be closed or opened based on the input/output inverted signal IIS.

For example, when the first input/output inverted signal IIS1 has the logic value of ‘1’, the fifth switch S5 may be closed and the sixth switch S6 may be opened. In detail, the first spike signal SS1 output through the inverting output terminal IoT may be provided to the delay circuit DLY and the output spike generator through the first terminal T1.

In contrast, when the second input/output inverted signal IIS2 has the logic value ‘0’, the fifth switch S5 may be opened and the sixth switch S6 may be closed. In detail, the first spike signal SS1 output again through the non-inverting output terminal NOT may be provided to the delay circuit DLY and the output spike generator through the first terminal T1.

The delay circuit DLY may output the logic value of the neuron reset signal NRS as ‘1’ based on the spike signal SS. The delay circuit DLY of FIG. 6 may correspond to the delay circuit DLY of FIG. 4. The delay circuit DLY may receive the spike signal SS having the logic value of ‘1’, and may provide the neuron reset signal NRS having the logic value of ‘1’ to the gate terminal of a second transistor TR2 after a specific period of time.

The second transistor TR2 may correspond to the first transistor TR1 in FIG. 4. The second transistor TR2 may be turned on by receiving the neuron reset signal NRS having the logic value of ‘1’. In this case, as the membrane voltage terminal is connected to the ground node GND, the potential level of the membrane voltage Vmk may fall to the potential level of the ground node GND. In detail, the membrane voltage Vmk may be reset. In other words, the neuron circuit NEK may be reset.

The output spike generator may output the input/output inverted signal IIS and the output spike signal SOK based on the spike signal SS.

When the spike signal SS is received in odd numbers (e.g., the first spike signal SS1, a third spike signal SS3, a fifth spike signal SS5, etc.), the output spike generator may output the logic value of the input/output inverted signal IIS as ‘1’ based on the spike signal SS.

For example, when the first spike signal SS1 having the logic value of ‘1’ is received, the output spike generator may output the logic value of ‘1’ as the first input/output inverted signal IIS1. In this case, the logic value of the output spike signal SOK may be ‘0’.

In contrast, when the spike signal SS is received in even numbers (e.g., the second spike signal SS2, a fourth spike signal SS4, a sixth spike signal SS6, etc.), the output spike generator may output the logic value of the input/output inverted signal IIS as ‘0’ based on the spike signal SS.

For example, when the second spike signal SS2 having the logic value of ‘1’ is received, the output spike generator may output the logic value of ‘0’ as the second input/output inverted signal IIS2. In addition, the output spike generator may output the output spike signal SOk.

A more detailed description of the output spike generator will be described later with reference to FIG. 7.

FIG. 7 is a detailed diagram illustrating an output spike generator of FIG. 6, according to some embodiments of the present disclosure. Referring to FIG. 7, the output spike generator is illustrated in detail.

The output spike generator may include a first flip-flop circuit FF1, a second flip-flop circuit FF2, and the delay circuit DLY. For example, the first flip-flop circuit FF1 and the second flip-flop circuit FF2 may each be a D-flip-flop.

The first flip-flop circuit FF1 may generate the input/output inverted signal IIS based on the first spike signal SS1.

For example, the first flip-flop circuit FF1 may generate the first input/output inverted signal IIS1 based on the first spike signal SS1.

In detail, the first flip-flop circuit FF1 may receive the first spike signal SS1 as a clock signal. The moment when the logic value of the first spike signal SS1 changes from ‘0’ to ‘1’, the first flip-flop circuit FF1 may output the first input/output inverted signal IIS1 having the logic value of ‘1’ through a first output terminal Q1. The first flip-flop circuit FF1 may provide the first input/output inverted signal IIS1 to the input switch circuit, the output switch circuit, and a first inverter 11, respectively. In this case, a first inverting output terminal Q1′ may provide the logic value ‘0’ to a first input terminal D1 connected to the first inverting output terminal Q1′.

As another example, the first flip-flop circuit FF1 may generate the second input/output inverted signal IIS2 based on the second spike signal SS2.

In detail, the first flip-flop circuit FF1 may receive the second spike signal SS2 as the clock signal. The moment when the logic value of the second spike signal SS2 changes from ‘0’ to ‘1’, the first flip-flop circuit FF1 may output the second input/output inverted signal IIS2 having the logic value of ‘0’ through the first output terminal Q1. The first flip-flop circuit FF1 may provide the second input/output inverted signal IIS2 to the input switch circuit, the output switch circuit, and the first inverter 11, respectively. In this case, the first inverting output terminal Q1′ may provide the logic value ‘1’ to the first input terminal D1 connected to the first inverting output terminal Q1′.

FIG. 7 illustrates only the first and second spike signals SS1 and SS2 and the first and second input/output inverted signals IIS1 and IIS2, but the scope of the present disclosure is not limited thereto and each of the signals may have three or more. In detail, when the output spike generator receives the odd-numbered spike signals (e.g., SS1, SS3, SS5, . . . ) having the logic value ‘1’, each logic value of odd-numbered input/output inverted signals (e.g., IIS1, IIS3, IIS5, . . . ) may change from ‘0’ to ‘1’. In contrast, when the output spike generator receives the even-numbered spike signals (e.g., SS2, SS4, SS6, . . . ) having the logic value ‘1’, each logic value of even-numbered input/output inverted signals (e.g., IIS2, IIS4, IIS6, . . . ) may change from ‘1’ to ‘0’.

The second flip-flop circuit FF2 may receive a signal obtained by inverting the input/output inverted signal IIS through the first inverter I1 as a clock signal. Therefore, the second flip-flop circuit FF2 may output the output spike signal SOK through a second output terminal Q2 at the moment when the logic value of the input/output inverted signal IIS changes from ‘1’ to ‘0’. The second inverted output terminal Q2′ may be connected to a second input terminal ‘D’

In detail, the second flip-flop circuit FF2 may output the output spike signal SOK as the logic value ‘1’ at the moment when the input/output inverted signal IIS changes from ‘1’ to ‘0’, that is, when the even-numbered spike signal SS is received.

The delay circuit DLY may receive the output spike signal SOK from the second flip-flop circuit FF2 and may provide a logic reset signal LRS to a reset terminal ‘reset’ of the first flip-flop circuit FF1 and the second flip-flop circuit FF2.

For example, when the output spike signal SOK having the logic value of ‘l’ is received, the delay circuit DLY may output the logic reset signal LRS having the logic value of ‘1’ after a specific time. Accordingly, the first flip-flop circuit FF1 and the second flip-flop circuit FF2 may each be reset to their initial states.

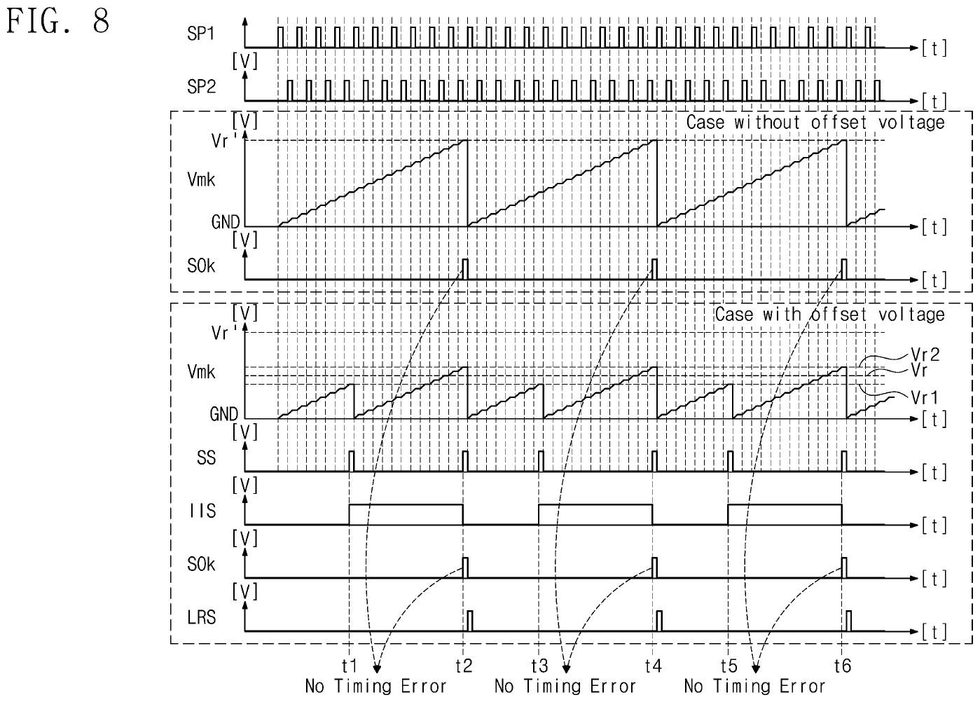

FIG. 8 is a timing diagram describing an operation of a spiking neural network circuit, according to some embodiments of the present disclosure. Referring to FIG. 8, operations of a synapse circuit and a neuron circuit according to input spike signals according to some embodiments of the present disclosure are described in the case of the absence of the offset voltage and the case of the presence of the offset voltage.

A horizontal axis of FIG. 8 may indicate a time ‘t’, and a vertical axis may indicate a voltage ‘V’. Among the signals in FIG. 8, signals having the same reference symbols as those in FIGS. 3 and 5 are the same signals as those in FIGS. 3 and 5, so additional descriptions will be omitted below to avoid redundancy.

When there is no offset voltage, that is, using an ideal comparator assuming no offset voltage, the moment when the membrane voltage Vmk becomes greater than a reference voltage Vr′, the logic value of the output spike signal SOK may be output as ‘1’. For example, the timings at which the neuron circuit outputs the output spike signal SOk as the logic value ‘1’ may be the second time t2, the fourth time t4, and the sixth time t6.

When there is the offset voltage, a detailed timing diagram of the spiking neural network circuit according to the present disclosure is as follows.

The reference voltage Vr when there is the offset voltage may be half of the reference voltage Vr′ when there is the offset voltage. The potential level of a first reference voltage Vr1 may be less than the potential level of the reference voltage Vr by the offset voltage. The potential level of a second reference voltage Vr2 may be greater than the potential level of the reference voltage Vr by the offset voltage.

First, at the first time t1 when the membrane voltage Vmk becomes greater than the first reference voltage Vr1, the comparator CP may output the logic value of the first spike signal SS1 as ‘1’.

The output signal generator may output the logic value of the first input/output inverted signal IIS1 as ‘1’ based on the first spike signal SS1. The membrane voltage Vmk may be reset to the potential level of the ground node GND by the neuron reset signal. In this case, the logic value of the output spike signal SOK may maintain ‘0’. In detail, the neuron circuit may not fire at the first time t1.

Based on the first input/output inverted signal IIS1, at the second time t2 when the membrane voltage Vmk becomes greater than the second reference voltage Vr2, the comparator CP may output the logic value of the second spike signal SS2 as ‘1’.

The output signal generator may output the logic value of the second input/output inverted signal IIS2 as ‘0’ based on the second spike signal SS2. In addition, the output signal generator may output the logic value of the output spike signal SOK as ‘1’. In detail, the neuron circuit may fire at the second time t2. The membrane voltage Vmk may be reset to the potential level of the ground node GND by the neuron reset signal.

Based on the first input/output inverted signal IIS2, at the second time t3 when the membrane voltage Vmk becomes greater than the first reference voltage Vr1, the comparator CP may output the logic value of the third spike signal SS3 as ‘1’.

The output signal generator may output the logic value of the first input/output inverted signal IIS3 as ‘1’ based on the third spike signal SS3. The membrane voltage Vmk may be reset to the potential level of the ground node GND by the neuron reset signal. In this case, the logic value of the output spike signal SOK may maintain ‘0’. In detail, the neuron circuit may not fire at the third time t3.

Based on the third input/output inverted signal IIS3, at the fourth time t4 when the membrane voltage Vmk becomes greater than the second reference voltage Vr2, the comparator CP may output the logic value of the fourth spike signal SS4 as ‘1’.

The output signal generator may output the logic value of the fourth input/output inverted signal IIS4 as ‘0’ based on the fourth spike signal SS4. In addition, the output signal generator may output the logic value of the output spike signal SOK as ‘1’. In detail, the neuron circuit may fire at the fourth time t4. The membrane voltage Vmk may be reset to the potential level of the ground node GND by the neuron reset signal.

As in the above description, based on the fourth input/output inverted signal IIS4, at the fifth time t5 when the membrane voltage Vmk becomes greater than the first reference voltage Vr1, the comparator CP may output the logic value of the fifth spike signal SS5 as ‘1’.

The output signal generator may output the logic value of the fifth input/output inverted signal IIS5 as ‘1’ based on the fifth spike signal SS5. The membrane voltage Vmk may be reset to the potential level of the ground node GND by the neuron reset signal. In this case, the logic value of the output spike signal SOK may maintain ‘0’. In detail, the neuron circuit may not fire at the fifth time t5.

Based on the fifth input/output inverted signal IIS5, at the sixth time t6 when the membrane voltage Vmk becomes greater than the second reference voltage Vr2, the comparator CP may output the logic value of the sixth spike signal SS6 as ‘1’.

The output signal generator may output the logic value of the sixth input/output inverted signal IIS6 as ‘0’ based on the sixth spike signal SS6. In addition, the output signal generator may output the logic value of the output spike signal SOK as ‘1’. In detail, the neuron circuit may fire at the sixth time t6. The membrane voltage Vmk may be reset to the potential level of the ground node GND by the neuron reset signal.

In other words, even when there is the offset voltage, the neuron circuit according to the present disclosure may fire at the second time t2, the fourth time t4, and the sixth time t6, the same as when there is no offset voltage. That is, there may be no timing error.

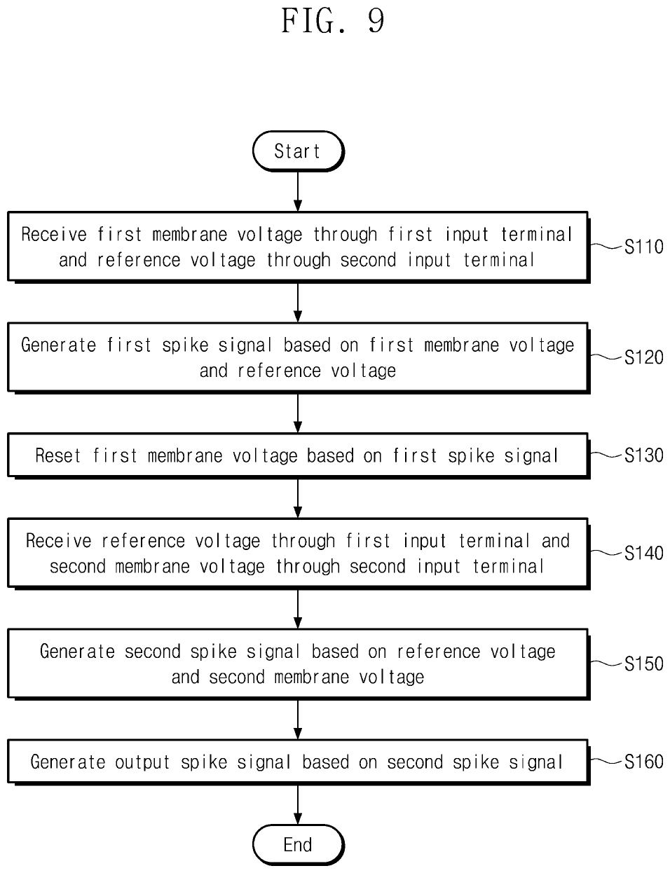

FIG. 9 is a flowchart describing an operation of a neuron circuit, according to an embodiment of the present disclosure. Referring to FIG. 9, a method of operating the neuron circuit will be described. The neuron circuit of FIG. 9 may correspond to the neuron circuit NEk of FIG. 6.

In operation S110, the neuron circuit may receive the first membrane voltage through the first input terminal and the reference voltage through the second input terminal.

Prior to this, the axonal circuit may generate a first input spike signal, the synapse circuit may generate a first current based on the first input spike signal and a weight, and the capacitor of the neuron circuit may form the first membrane voltage based on the first current.

In operation S120, the neuron circuit may generate the first spike signal based on the first membrane voltage and the reference voltage.

In some embodiments, the neuron circuit may output the logic value of the first spike signal as ‘1’ at the moment when the first membrane voltage becomes greater than or equal to the reference voltage. In other words, the neuron circuit may fire.

In some embodiments, operation S120 may further include generating the first input/output inverted signal based on the first spike signal.

In some embodiments, the neuron circuit may output the first spike signal through the non-inverting output terminal.

In operation S130, the neuron circuit may reset the first membrane voltage based on the first spike signal.

In some embodiments, the neuron circuit may generate the neuron reset signal based on the first spike signal. The capacitor of the neuron circuit may lower the first membrane voltage to the potential level of the ground node GND based on the neuron reset signal. In detail, the neuron circuit may reset the first membrane voltage.

In operation S140, the neuron circuit may receive the reference voltage through the first input terminal and the second membrane voltage through the second input terminal.

In some embodiments, operation S140 may include changing the voltage received through the first input terminal from the first membrane voltage to the reference voltage based on the first input/output inverted signal, and changing the voltage received through the second input terminal from the reference voltage to the second membrane voltage based on the first input/output inverted signal.

Prior to this, the axonal circuit may generate the second input spike signal, the synapse circuit may generate the second current based on the second input spike signal and the weight, and the capacitor of the neuron circuit may form the second membrane voltage based on the second current after the first membrane voltage is reset.

In operation S150, the neuron circuit may generate the second spike signal based on the reference voltage and the second membrane voltage.

In some embodiments, operation S150 may further include generating the second input/output inverted signal based on the second spike signal.

In some embodiments, operation S150 may include changing the voltage received through the first input terminal from the reference voltage to the third membrane voltage based on the second input/output inverted signal, and changing the voltage received through the second input terminal from the second membrane voltage to the reference voltage based on the second input/output inverted signal.

Prior to this, the axonal circuit may generate the third input spike signal, the synapse circuit may generate the third current based on the third input spike signal and the weight, and the capacitor of the neuron circuit may form the third membrane voltage based on the third current after the second membrane voltage is reset.

In some embodiments, the neuron circuit may output the second spike signal through the non-inverting terminal.

In operation S160, the neuron circuit may generate the output spike signal based on the second spike signal.

According to an embodiment of the present disclosure, a spiking neural network circuit that generates spike signals and a method of operating the same are provided.

In addition, according to an embodiment of the present disclosure, a spiking neural network circuit with improved precision and a method of operating the same are provided by allowing the comparator to operate as if there is no offset voltage, by receiving the reference voltage and the membrane voltage through the input terminals of the comparator of the neuron circuit and performing a comparison operation, and then by exchanging the reference voltage and the membrane voltage and performing a comparison operation again.

The above descriptions are detail embodiments for carrying out the present disclosure. Embodiments in which a design is changed simply or which are easily changed may be included in the present disclosure as well as an embodiment described above. In addition, technologies that are easily changed and implemented by using the above embodiments may be included in the present disclosure. Therefore, the scope of the present disclosure should not be limited to the above-described embodiments and should be defined by not only the claims to be described later, but also those equivalent to the claims of the present disclosure.

What is claimed is:

1. A spiking neural network circuit comprising:
an axon circuit configured to generate a first input spike signal and a second input spike signal;
a synapse circuit configured to generate a first current based on the first input spike signal and a weight, and to generate a second current based on the second input spike signal and the weight;
a capacitor configured to form a first membrane voltage based on the first current; and
a neuron circuit including a comparator and configured to reset the first membrane voltage, and
wherein after the capacitor is reset by the neuron circuit, and further forms a second membrane voltage based on the second current, and
wherein the comparator is configured to:
include a first input terminal and a second input terminal;
receive the first membrane voltage through the first input terminal and a reference voltage through the second input terminal;
generate a first spike signal based on a first comparison operation of the first membrane voltage and the reference voltage;
reset the first membrane voltage of the capacitor based on the first spike signal;
receive the reference voltage through the first input terminal and the second membrane voltage through the second input terminal, based on the first spike signal;
generate a second spike signal based on a second comparison operation of the reference voltage and the second membrane voltage.

2. The spiking neural network circuit of claim 1, wherein the neuron circuit further includes an output spike generator, and
wherein the output spike generator is configured to:
receive the first spike signal and the second spike signal, to generate a first input/output inverted signal based on the first spike signal, and to generate a second input/output inverted signal and an output spike signal based on the second spike signal.

3. The spiking neural network circuit of claim 2, wherein the neuron circuit is configured to:
change a voltage that the comparator receives through the first input terminal from the first membrane voltage to the reference voltage, based on the first input/output inverted signal, and to change a voltage that the comparator receives through the second input terminal from the reference voltage to the second membrane voltage.

4. The spiking neural network circuit of claim 1, wherein the axon circuit is further configured to generate a third input spike signal,
wherein the synapse circuit is further configured to generate a third current based on the third input spike signal and the weight,
wherein the capacitor further forms a third membrane voltage based on the third current after the second membrane voltage is reset by the neuron circuit, and
wherein the comparator is configured to:
receive the third membrane voltage through the first input terminal and the reference voltage through the second input terminal;
generate a third spike signal based on a third comparison operation of the third membrane voltage and the reference voltage; and
reset the second membrane voltage of the capacitor based on the third spike signal.

5. The spiking neural network circuit of claim 4, wherein the neuron circuit:
further includes an output spike generator configured to receive the second spike signal and to generate a second input/output inverted signal and an output spike signal based on the second spike signal; and
is configured to change a voltage that the comparator receives through the first input terminal from the reference voltage to the third membrane voltage, based on the second input/output inverted signal, and to change a voltage that the comparator receives through the second input terminal from the second membrane voltage to the reference voltage.

6. The spiking neural network circuit of claim 2, wherein the output spike generator includes:
a first flip-flop circuit configured to generate a first input/output inverted signal based on the first spike signal, and to generate a second input/output inverted signal based on the second spike signal; and
a second flip-flop circuit configured to generate the output spike signal based on the second input/output inverted signal.

7. The spiking neural network circuit of claim 1, wherein the first input terminal is a non-inverting input terminal, and the second input terminal is an inverting input terminal.

8. The spiking neural network circuit of claim 1, wherein the comparator further includes a non-inverting output terminal and an inverting output terminal, and
wherein the comparator is configured to:
output the first spike signal through the non-inverting output terminal; and
output the second spike signal through the inverting output terminal.

9. A method of operating a spiking neural network circuit including an axon circuit, a synapse circuit, and a neuron circuit, the method comprising:
generating, by the axon circuit, a first input spike signal;
outputting, by the synapse circuit, a first current based on the first input spike signal and a weight;
generating, by a capacitor of the neuron circuit, a first membrane voltage based on the first current;
receiving, by a comparator of the neuron circuit, the first membrane voltage through a first input terminal of the comparator and a reference voltage through a second input terminal of the comparator;
generating, by the comparator, a first spike signal based on the first membrane voltage and the reference voltage;
resetting, by the neuron circuit, the first membrane voltage based on the first spike signal;
generating, by the axon circuit, a second input spike signal;
outputting, by the synapse circuit, a second current based on the second input spike signal and a weight;
forming, by the capacitor, a second membrane voltage based on the second current;
receiving, by the comparator, the reference voltage through the first input terminal and the second membrane voltage through the second input terminal; and
generating, by the comparator, a second spike signal based on the reference voltage and the second membrane voltage.

10. The method of claim 9, wherein the neuron circuit further includes an output spike generator, and
wherein the generating, by comparator, of the first spike signal based on the first membrane voltage and the reference voltage further includes:
generating, by the output spike generator, a first input/output inverted signal based on the first spike signal, and
wherein the receiving, by the comparator, of the reference voltage through the first input terminal and of the second membrane voltage through the second input terminal includes:
changing, by the neuron circuit, a voltage that the comparator receives through the first input terminal from the first membrane voltage to the reference voltage, based on the first input/output inverted signal; and
changing, by the neuron circuit, a voltage that the comparator receives through the second input terminal from the reference voltage to the second membrane voltage, based on the first input/output inverted signal.

11. The method of claim 9, further comprising:
generating, by the axon circuit, a third input spike signal;
generating, by the synapse circuit, a third current based on the third input spike signal and the weight;
forming, by the capacitor, a third membrane voltage based on the third current;
receiving, by the comparator, the third membrane voltage through the first input terminal and the reference voltage through the second input terminal; and
generating, by the comparator, a third spike signal based on the third membrane voltage and the reference voltage.

12. The method of claim 11, wherein the neuron circuit further includes an output spike generator, and
wherein the generating, by the comparator, of the second spike signal based on the reference voltage and the second membrane voltage further includes:
generating, by the output spike generator, a second input/output inverted signal based on the second spike signal, and
wherein the receiving, by the comparator, of the third membrane voltage through the first input terminal and of the reference voltage through the second input terminal includes:
changing, by the neuron circuit, a voltage that the comparator receives through the second input terminal from the reference voltage to the third membrane voltage, based on the second input/output inverted signal; and
changing, by the neuron circuit, a voltage that the comparator receives through the second input terminal from the second membrane voltage to the reference voltage, based on the second input/output inverted data.

13. The method of claim 12, wherein the generating, by the output spike generator, of the second input/output inverted signal based on the second spike signal further includes:
generating, by the output spike generator, a first output spike signal based on the second spike signal.

14. The method of claim 8, wherein the comparator includes a non-inverting output terminal and an inverting output terminal, and
wherein the comparator is configured to output the first spike signal through the non-inverting output terminal, and to output the second spike signal through the inverting output terminal.
